(19) United States
(12) Patent Application Publication
(10) Pub. No.: US 2025/0323879 A1
(43) Pub. Date: Oct. 16, 2025

(54) EGRESS PORT ACTIVATION

(71) Applicant: MELLANOX TECHNOLOGIES, LTD., Yokneam (IL)

(72) Inventors: Amit Kazimirsky, Givat-Shmuel (IL); Nir Sucher, Ramat Hashofet (IL)

(21) Appl. No.: 18/636,660

(22) Filed: Apr. 16, 2024

(51) Int. Cl. H04L 49/00

(52) U.S. Cl. CPC H04L 49/30

(57) ABSTRACT

An interconnect device is provided. In one example, an interconnect device includes circuits capable of receiving a request via an ingress port; in response to receiving the request, identifying one or more egress ports associated with the ingress port; activating the one or more egress ports associated with the ingress port; receiving data via the ingress port; processing the received data to identify an egress port associated with a destination of the data; and scheduling the data to be forwarded from the egress port associated with the destination of the data.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity. As a result, conventional switches consume amounts of power which may be unnecessarily high during periods of low traffic.

### BRIEF SUMMARY

Data centers and other computing environments, such as those employing artificial intelligence (AI) training systems, use a network infrastructure, which may be referred to as a fabric, which provides interconnectivity between various components, facilitating rapid data transfer and communication for handling large volumes of data and computationally intensive tasks. Such computing environments may utilize a fabric of processing devices such as graphics processing units (GPUs) and switches to provide computing capabilities for hosts devices such as personal computers and servers.

In such computing environments there may be periods of time during which portions of the fabric are idle or partially idle in terms of traffic. For example, switches may be used in bursts to provide interconnectivity to GPUs and may remain idle or partially idle as the GPUs perform computing functions. Conventionally, a significant amount of power is wasted in such scenarios. However, using a system or method as described herein, links may be opened when traffic is expected to arrive and may be taken down to a low power state (L1) during idle periods. As used herein, L1 may refer to a lower power state in which a switch or a link may be capable of receiving data but must first activate circuitry associated with one or more ports to be able to process and/or forward the data.

A switch as described herein may include a number of ports. Each port may be capable of entering L1 independently from other ports. In this way, one or more ports of a switch may be in L1 while other ports are active.

For a link to exit from L1 and operate as a fully activated link, the link must be woken up. The latency of exiting from L1 is relatively long and may impact the performance of the fabric. This issue is exacerbated in larger networks where the number of hops through switches between compute entities is increased because wake latencies can accumulate.

The systems and methods described herein provide a hardware implementation that caches the latest ports communication inside the switch in order to improve links wake time of the next ports needed to be waked. When a link wakes from L1, the wake time is divided between different entities until the link becomes fully operational. During this time, the observation that the link is going to be up can be concluded very fast (for example, less than ten microseconds as compared to one-hundred or more microseconds with conventional solutions).

With conventional systems, an egress port does not exit from L1 until a packet arrives, is processed, and a determination as to which egress port. However, using a system or method as described herein, when data is received at a port, one or more egress ports which recently transmitted packets received at the port can be woken from L1. Based on the locality principle, a port is likely to address ports that it has most recently addressed before the idle time. Therefore, using a system or method as described herein, each ingress port may use a cache lookup. Once the ingress port starts to wake up, the cache lookup may be used to determine one or more egress ports to also wake. Using such a chain mechanism, performance issues in big network topologies can be reduced to a single wake-up time for most of the repetitive use cases.

In accordance with one or more embodiments described herein, a computing system, such as an interconnect device, may enable a diverse range of systems, such as switches, servers, personal computers, and other computing devices, to communicate across a network in an energy efficient manner. Such a computing system, which may be referred to herein as an interconnect device or switch, may implement one or more L1 exit propagation mechanisms to selectively activate or wake egress ports before such egress ports are required for transmitting data.

Implementing such a system or method may include logging port associations in memory. For example, when a link is established in which packets received at a first port are transmitted from a second port, a cache associated with the first port may be updated to list the second port. Over time, as the first port uses other ports to transmit data, the other ports may likewise be added to the cache. If one of the ports listed in the cache is not used for a particular amount of time, the port may be removed from the cache. In this way, the cache may continuously list the most recently used ports. When data is received at the first port, a processing circuit may perform a lookup to determine the contents of the cache and may begin to wake any port listed in the cache. Such ports may or may not be necessary for transmitting packets associated with the data received at the first port; however, based on the likelihood of at least one of the ports being required to forward the data, the system or method may provide an energy-efficient and low-latency solution as compared to conventional solutions.

The present disclosure describes a system and method for enabling an interconnect device, such as a switch, or other computing system to reduce overall power consumption by offering a feature in which the interconnect device selectively wakes egress ports from L1 in response to receiving data at an ingress port.

In an illustrative example, a device is disclosed that includes one or more circuits to: receive a request via an ingress port; in response to receiving the request, identify one or more egress ports associated with the ingress port; activate the one or more egress ports associated with the ingress port; receive data via the ingress port; process the received data to identify an egress port associated with a destination of the data; and schedule the data to be forwarded from the egress port associated with the destination of the data.

In another example, a switch is disclosed that includes a plurality of ports and one or more circuits to: receive a request via an ingress port; in response to receiving the request, identify one or more egress ports associated with the ingress port; activate the one or more egress ports associated with the ingress port; receive data via the ingress port; process the received data to identify an egress port associated with a destination of the data; and schedule the data to be forwarded from the egress port associated with the destination of the data.

In yet another example, a method is disclosed that includes receiving data via an ingress port; in response to receiving the data via the ingress port, identifying one or more egress ports associated with the ingress port; activating the one or more egress ports associated with the ingress port; processing the received data to identify an egress port associated with a destination of the data; and scheduling the data to be forwarded from the egress port associated with the destination of the data.

Any of the above example aspects may include any one or more of: wherein the request is a request to wake the ingress port; wherein the one or more circuits are further to wake the ingress port in parallel with activating the one or more egress ports in response to the request; wherein the ingress port is deactivated and unable to receive data when the one or more egress ports are activated; wherein the ingress port is associated with a cache in memory, and the one or more circuits identify the one or more egress ports associated with the ingress port by reading the cache; wherein the one or more circuits are further to save an identification of the egress port associated with the destination of the data in the cache; wherein the one or more circuits identify the one or more egress ports by receiving an output from a reinforcement learning model; wherein the one or more circuits are further to train the reinforcement learning model based on the egress port associated with the destination of the data; wherein the one or more circuits activate the one or more egress ports associated with the ingress port in parallel with performing an input negotiation associated with the ingress port; wherein the one or more egress ports associated with the ingress port comprise a plurality of egress ports; wherein the one or more circuits activate the one or more egress ports associated with the ingress port by exiting the one or more egress ports from a low power state; wherein the one or more circuits activate the one or more egress ports associated with the ingress port prior to or in parallel with performing an output link decoding; and wherein the one or more circuits are further to activate the egress port associated with the destination of the data after activating the one or more egress ports associated with the ingress port.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIG. 3 is a block diagram depicting an illustrative configuration of routing circuitry of an interconnect device in accordance with at least some embodiments of the present disclosure;

FIG. 4 is a block diagram depicting contents of memory of an interconnect device in accordance with at least some embodiments of the present disclosure;

FIG. 5 is a flowchart depicting an illustrative configuration of a method in accordance with at least some embodiments of the present disclosure; and

FIG. 6 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

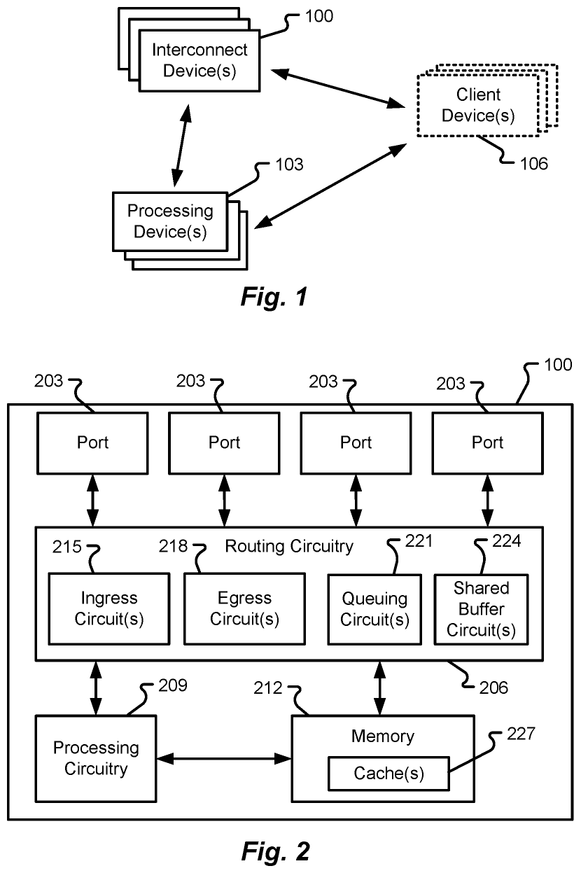

Referring now to FIGS. 1-6, various systems and methods for implementing an L1 exit mechanism in an interconnect device will be described. The concepts of waking egress ports depicted and described herein can be applied to any type of computing system capable of receiving and/or transmitting data, whether the computing system includes one port or a plurality of ports. Such a computing system may be a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing. As such, the need for power-efficient interconnect devices is growing. The systems and methods described herein may be used to reduce overall power consumption for interconnect devices.

As illustrated in FIG. 1, a computing environment as described herein may be a network of processing devices 103 which may be interconnected by a fabric. A fabric as described herein may include one or more interconnect devices 100 and/or one or more processing devices 103. The one or more interconnect devices 100 may be in communication with the processing devices 103 as well as one or more other computing systems such as client devices 106. Such a network of processing devices 103 and interconnect devices 100 may be useful in various settings, from data centers and cloud computing infrastructures to AI systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as GPUs, central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may also or alternatively include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100 as described in greater detail herein may enable communication between processing devices 103 and/or client devices 106. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 may be capable of receiving, processing, and forwarding data, e.g., packets, to appropriate destinations within the network, such as processing devices 103 and/or client devices 106. In some implementations, an interconnect device 100 as described herein may be included in a switch box, a platform, or a case which may contain one or more interconnect devices 100 as well as one or more power supply devices.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 106. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Client devices 106 as described herein may be computing devices which, for example, engage in AI-related, research-related, and other processor-intensive tasks, and utilize processing devices 103 to handle the computational loads and data throughput required by such intensive applications. Client devices 106 may include, for example, workstations and personal computers used by researchers, data scientists, and professionals for developing, testing, and running AI models and research simulations. Client devices 106 may include one or more CPUs and/or GPUs but may require additional computational power for complex tasks.

By interacting with processing devices 103, client devices 106 may be enabled to perform functions such as training machine learning models, performing data processing, running simulations, analyzing large datasets, and performing complex data processing tasks, such as data mining, pattern recognition, and predictive modeling, for examples.

An interconnect device 100 as described herein may in some implementations be as illustrated in FIG. 2. Such an interconnect device 100 may include a plurality of ports 203, routing circuitry 206, processing circuitry 209, and memory 212.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 106.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device 100 and an ingress port 203 may be used solely for receiving incoming data into the interconnect device 100.

As referenced above, using a system or method as described herein, links may be opened when traffic is expected to arrive and may be taken down to L1 during idle periods. When a link is in L1, an interconnect device 100 or the link may be capable of receiving data but must first activate circuitry associated with one or more ports 203 to be able to process and/or forward the data. Each port 203 of an interconnect device 100 may be capable of entering L1 independently from other ports 203. In this way, one or more ports 203 of an interconnect device 100 may be in L1 while other ports 203 of the interconnect device 100 are active.

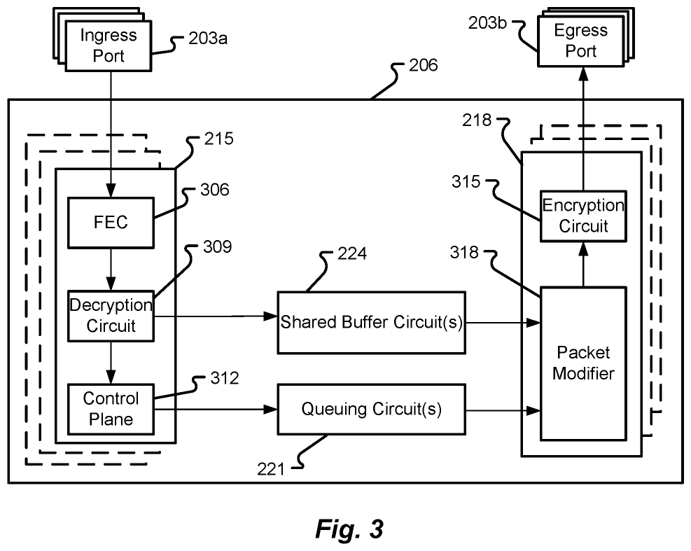

Routing circuitry 206 of an interconnect device 100, as described in greater detail below and in relation to FIG. 3, may be capable of handling a received packet by determining an egress port 203b from which to send the packet and forwarding the packet from the determined egress port 203b. Using a system or method as described herein, routing circuitry 206 may be capable of dynamically entering and/or exiting ports 203 from L1. As a result, the routing circuitry 206 may be capable of reducing an overall amount of power consumed by the interconnect device 100 without incurring a penalty in latency.

The routing circuitry 206 of the interconnect device 100 may include one or more ingress circuits 215 and egress circuits 218 as described in greater detail below. Each ingress port 203a may be associated with one or more ingress circuits 215 and each egress port 203b may be associated with one or more egress circuits 218. In some implementations, a single port 203 may be capable of acting as both an ingress port 203a and an egress port 203b. In such implementations, the port 203 may be associated with both one or more ingress circuits 215 and one or more egress circuits 218. Each ingress circuit 215 may be associated with an ingress port 203a and each egress circuit 218 may be associated with an egress port 203b. When a port 203 enters L1, one or more components included in the ingress circuit 215 and/or egress circuit 218 associated with the port 203 may be disabled or enter a low-power mode. When a port 203 exits L1, one or more components included in the ingress circuit 215 and/or egress circuit 218 associated with the port 203 may be enabled or enter a regular-power mode.

In support of the functionality of the routing circuitry 206, processing circuitry 209 may be configured to control aspects of the routing circuitry 206 to accomplish dynamically entering and/or exiting ports 203 from L1 by selectively powering on and off components included in ingress circuits 215 and egress circuits 218. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle level management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools.

Routing circuitry 206 may include one or more circuits and components such as ingress circuits 215, egress circuits 218, queuing circuits 221, shared buffer circuits 224, and/or other circuits and components which may be used to process and forward packets received by the interconnect device 100. Each of these examples and others may be as described in greater detail below and may be capable of being selectively enabled and disabled, in whole or in part, based on packets received by the interconnect device 100.

Memory 212 of an interconnect device 100 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

As described in greater detail below, memory 212 may store one or more caches 227. Each cache 227 may include a number of entries and may be associated with a particular port 203 of the interconnect device 100. As described below, each cache 227 may store data identifying one or more egress ports 203 from which data received at the port 203 associated with the cache 227 is transmitted.

FIG. 3 illustrates elements of routing circuitry 206 of an interconnect device 100 in accordance with one or more implementations of the present disclosure. One or more ingress ports 203a may, upon receiving data, transmit the data to one or more ingress circuit 215. In some implementations, each ingress port 203a may be associated with a dedicated ingress circuit 215, while in other implementations, multiple ingress ports 203b may share an ingress circuit 215.

Each ingress circuit 215 may include one or more of a forward error correction (FEC) circuit 306, a decryption circuit 309, a control plane 312, and/or other circuits and components which may handle ingress packets and/or non-packetized ingress data. An FEC circuit 306 as described herein may be used to perform error detection and correction for packets received from an ingress port 203a before the packets are directed to an egress port 203b. The FEC circuit 306 may receive ingress data from an ingress port 203a and, after performing FEC, output the received ingress data or a processed version of the ingress data to a decryption circuit 309.

A decryption circuit 309 as described herein may be used to decrypt all or a portion of received packets to enable the interconnect device 100 to determine an egress port 203b from which to send each packet. The decryption circuit 309 may be capable of ensuring that sensitive data remains protected from unauthorized access during traversal of the data through the interconnect device 100. The decryption circuit 309 may output received packets or data associated with received packets to one or more shared buffer circuits 224 as described below. The decryption circuit 309 may also output data associated with received packets to the control plane 312.

A control plane 312 as described herein may be used to manage how received data packets are forwarded and handled within the interconnect device 100. The control plane 312 may receive data associated with a received packet from the decryption circuit 309 and, based on the data associated with received packet, write instructions to one or more queueing circuits 221 as described below.

A control plane 312 may include one or more components such as one or more RAM circuits, ASICs, FPGAs, flash memory, network interface cards (NICs), content addressable memory (CAM) circuits, port logic circuits, serializer/deserializer (SerDes) circuits, and clock tree circuits, for example. Each component of the control plane 312 may be capable of being selectively enabled and/or disabled based on packets received by the interconnect device 100. The control plane 312 may be referred to herein as an ingress control plane. Different packets handled by the interconnect device 100 may require a different set or subset of components of the control plane 312 to be forwarded. As described herein, a controller or control circuit may be used which determines which components are required for a received packet and ensures the required components are enabled.

Each of the FEC circuit 306, decryption circuit 309, control plane 312, and/or other circuits and components of the ingress circuits 215 may include one or more of an ASIC, FPGA, digital signal processor (DSP), network processor, accelerator, hardware secure module, CPU, and/or other components and circuits capable of performing ingress processing. As should be appreciated, each ingress circuit 215 of an interconnect device 100 may include one or more additional circuits and components in addition to or instead of the FEC circuit 306, decryption circuit 309, and control plane 312 described above.

Each of the ingress circuits 215 of the interconnect device 100 may be enabled to write data to a shared-buffer circuit 224 and a queueing circuit 221. Packets to be egressed from the interconnect device 100 may be stored in the shared-buffer circuit 224. Data which may be used by egress circuits 218 to route packets to egress ports 203b may be written to the queuing circuits 221. Once a queueing circuit 221 assigns a particular packet to a particular egress port 203b, packet data stored in the shared buffer circuit 224 may be read by an egress circuit 218 associated with the particular egress port 203b.

Data to be sent from the interconnect device 100 may be processed by one or more egress circuits 218. In some implementations, each port 203b used for egress may be associated with a dedicated egress circuit 218. In other implementations, multiple egress ports 203b may share one or more egress circuits 218.

An egress circuit 218 may include, but should not be considered as limited to, a packet modifier 318 and an encryption circuit 315. A packet modifier 318 as described herein may include circuitry such as one or more RAM circuits, ASICs, FPGAs, flash memory, NICs, CAM circuits, port logic circuits, SerDes circuits, and clock tree circuits, or other componentry capable of adjusting packets before the packets are transmitted from the interconnect device. Such adjustments may include, for example, the adding or removal of tags, modification of settings and packet header data, and other modifications.

Each component of the packet modifier 318 may be capable of being selectively enabled and/or disabled based on packets received by the interconnect device 100. The packet modifier 318 may be referred to herein as an egress control plane. Different packets handled by the interconnect device 100 may require a different set or subset of components of the packet modifier 318 to be forwarded. As described herein, a controller or control circuit may be used to dynamically enter and/or exit ports 203 from L1 by selectively powering on and off components included in ingress circuits 215 and egress circuits 218. Such a controller or control circuit may be the processing circuitry 209 described above or another processing device.

An encryption circuit 315 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress circuit 218, a packet may be transmitted from the interconnect device 100 via an egress port 203b. The egress port 203b may be directly connected to an ultimate destination of the packet or may be connected to another interconnect device 100 which may forward the packet towards the ultimate destination.

As described above, components of the routing circuitry 206 of an interconnect device 100 may be capable of entering and exiting L1. As a result, the routing circuitry 206 may be capable of reducing an overall amount of power consumed by the interconnect device 100. Using a system or method as described herein, the power consumption may be achieved without incurring a penalty in latency.

The reduction of the overall power consumption of the interconnect device 100 may be achieved through the selective enabling and disabling of components of ingress circuits 215 and egress circuits 218. For an ingress port 203a to enter L1, one or more components of an ingress circuit 215 may be powered off or may be put into a low-power mode. For the ingress port 203a to exit L1, the one or more components of the ingress circuit 215 may be powered on or may be taken out of the low-power mode. For an egress port 203b to enter L1, one or more components of an egress circuit 218 may be powered off or may be put into a low-power mode. For the egress port 203b to exit L1, the one or more components of the egress circuit 218 may be powered on or may be taken out of the low-power mode. The selective enabling and disabling of components of the ingress circuits 215 and egress circuits 218 may be performed by a processing circuitry 209 as described above or a control circuit such as one or more of, or a combination of, an ASIC, an FPGA, and/or other componentry capable of performing the functions described herein.

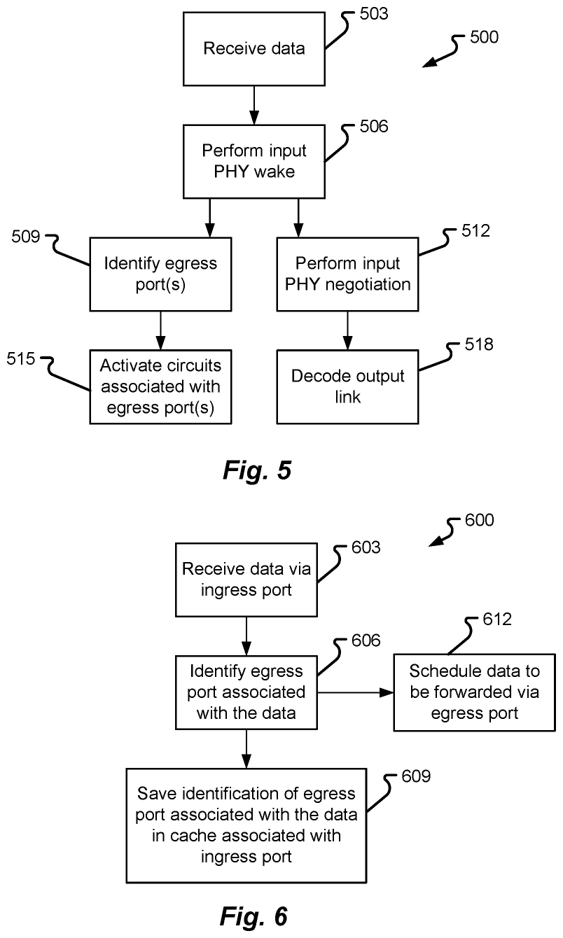

The processing circuitry 209 may be capable of detecting data being received at an ingress port 203a of the interconnect device 100, polling a cache 227 associated with the ingress port 203a in memory 212, identifying one or more egress ports 203b, and activating one or more components of egress circuits 218 associated with the one or more egress ports 203b to exit the egress ports 203b from L1, if such ports 203 are in L1 when the data is received at the ingress port 203a. This process may be via the performance of a method 500 as described in greater below in relation to FIG. 5.

When data is forwarded from the interconnect device 100, the processing circuitry 209 be capable of identifying the ingress port 203a at which the data was received and the egress port 203b from which the data was transmitted. The processing circuitry 209 may write data identifying the egress port 203b in a cache 227 associated with the ingress port 203a in memory 212. In this way, each cache 227 may keep a log of recent egress ports 203b used by an ingress port 203a associated with the respective cache 227.

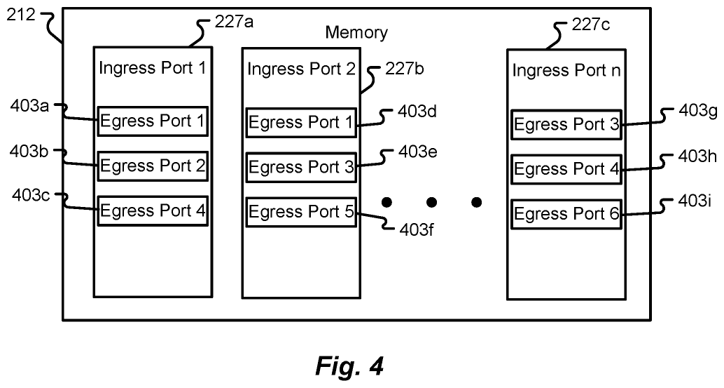

FIG. 4 is an illustration of memory 212 storing a number of caches 227a-c. A first cache 227a is illustrated as being associated with an ingress port 1, a second cache 227b is illustrated as being associated with an ingress port 2, and an nth cache 227c is illustrated as being associated with an ingress port n. While the caches 227a-c of FIG. 4 are each illustrated as being associated with a single ingress port 203a, it should be appreciated that in some implementations other arrangements may be deployed. For example, one cache 227 may be associated with a group of ports 203.

Each cache 227a-c may store identifications 403a-i of egress ports 203b. In the example illustrated in FIG. 4, the cache 227a associated with ingress port 1 includes identifications 403a-c of egress ports 1, 2, and 4, the cache 227b associated with ingress port 2 includes identifications 403d-f of egress ports 1, 3, and 5, and the cache 227c associated with ingress port n includes identifications 403g-i of egress ports 3, 4, and 6. The specific numbers of the egress ports 203b identified in each cache 227a-c should be considered as being included for illustration purposes only and should not be considered as limiting in any way.

Egress ports 203b may be represented in the caches 227 in a number of ways in various implementations. As an example, each port 203b may be represented by a port number or by a bit of a binary number. When a processing circuitry detects an ingress port 203a has received data which was or will be transmitted by a particular egress port 203b, the processing circuitry may edit the cache 227 associated with the ingress port to include an identification of the egress port 203b.

FIG. 5 is a flowchart of a method 500 in which egress circuits 218 are activated in response to data received at an ingress port 203a. As described in greater detail below, the egress circuits 218 are activated in parallel with input negotiation and output link decoding. By performing a method 500 as described herein, an interconnect device 100 may be enabled to wake links in a reduced amount of time as compared to conventional methods.

The method 500 may be implemented by an interconnect device 100, such as a switch, as described herein to enable reduced power consumption of an interconnect device 100 without incurring the latency caused by conventional methods. As described above, an interconnect device 100 may be, for example, a switch or other type of computing system capable of receiving and forwarding data in a network. The interconnect device 100 may be utilized by one or more processing devices 103 and/or client devices 106 to provide interconnect services with one or more other processing devices 103 and/or client devices 106.

The process may begin at 503 when a request is received at a port 203a of the interconnect device 100. The request received which may begin the process may in some implementations include a signal indicating incoming traffic, a link pulse, a handshake signal, or other data which may indicate the port 203a will begin to receive traffic from a source.

A request as described herein may be data in the form of an electrical or optical signal that physically represents the start of data transmission. A request may in some implementations be encapsulated within one or more data packets according to specific protocols. In such implementations a request may include header data and payload data. Header data of a request may include information such as source and destination addresses, protocol types, and other information. A request may be a part of a handshake signal utilizing a protocol such as TCP or IP.

Upon a request being received at the port 203a, an input physical layer (PHY) wake may be performed at 506. An input PHY wake may involve transitioning one or more components of an ingress circuit 215 associated with the port 203a which received the data from a low-power or inactive state to an active state. Such components may include, for example, one or more of an FEC 306, a decryption circuit 309, and/or a control plane 312. An input PHY wake may be necessary when the port 203a is in L1 when the data is received and the ingress circuit 215 associated with the port 203a is deactivated or in a low-power mode.

In response to, or simultaneous with, performing the input PHY wake at 506, the interconnect device 100 may identify one or more egress ports 203b at 509 and perform an input PHY negotiation at 512.

Identifying the one or more egress ports 203b at 509 may in some implementations include detecting the data received at the ingress port 203a, identifying the ingress port 203a, reading a cache 227 associated with the identified ingress port 203a to determine identifications of one or more egress ports 203b. As described above, each ingress port 203a may be associated with a cache 227. By reading the cache 227 associated with the ingress port 203a, the interconnect device 100 may be capable of determining one or more egress ports 203b which previously transmitted data received by the ingress port 203a. In some implementations, the interconnect device 100 may decode the egress port identification data in the cache to determine the egress ports 203b associated with the ingress port 203a.

While certain implementations described herein involve accessing a cache 227 to identify the one or more egress ports 203b associated with the ingress port 203a receiving the data, other implementations may employ other methods of identifying egress ports 203b associated with the ingress port 203a receiving the data. For example, and as described in greater detail below, in some implementations, the one or more egress ports 203b may be identified based on an output from an AI or machine learning (ML) model such as a reinforcement learning model. In other implementations, other methods of identifying one or more egress ports 203b associated with the ingress port 203a receiving the data may be employed.

Performing the input PHY negotiation at 512 may in some implementations include the interconnect device 100 undergoing a negotiation process with a source of the data received at the port 203a. The input PHY negotiation may involve negotiating parameters such as data rate, duplex mode, encoding schemes, etc. As an example, the interconnect device 100 may use an auto-negotiation protocol to exchange its capabilities with the source of the data and select a highest performance mode supported by both the interconnect device 100 and the source device.

Identifying the one or more egress ports 203b at 509 and performing the input PHY negotiation at 512 may be performed in parallel at the same or substantially the same time. Both identifying the one or more egress ports 203b at 509 and performing the input PHY negotiation at 512 may be prompted by the data received at the ingress port 203a at 503 and/or by the input PHY wake at 506.

Upon completing the input PHY negotiation at 512, the interconnect device may decode an output link at 518. Decoding the output link may in some implementations involve processing the received data to determine outgoing link information. For example, the interconnect device 100 may determine a correct format for the data, apply one or more encoding schemes, or perform other operations to prepare the received data for transmission. Decoding the output link may also or alternatively involve determining an egress port 203b from which to transmit the received data or future packets associated with the received data.

Before, simultaneous with, or after decoding the output link at 518, the interconnect device 100 may, upon identifying the one or more egress ports 203b at 509, activate egress circuits 218 associated with each of the identified egress ports 203b at 515. For example, activating the egress circuits 218 associated with the one or more identified egress ports 203b may be performed simultaneously with performing an input PHY negotiation at 512 as described above. As a result of activating the egress circuits, the one or more egress ports 203b may be activated. The activation of the egress ports 203b may occur prior to or simultaneous with the decoding of the output link at 518 and/or the input PHY negotiation at 512.

Activating the egress circuits 218 may involve performing an output PHY wake followed by an output PHY negotiation. Similar to the input PHY wake at 506 as described above, performing an output PHY wake may involve activating one or more components of egress circuits 218 from a low-power or inactive state. Such components may be, for example, an encryption circuit 315 and/or a packet modifier 318 as illustrated in FIG. 3.

Upon decoding the output link at 518, the interconnect device 100 may be configured to determine whether the specific egress port 203b needed for forwarding the received data and/or data associated with the received data is active. If the port 203b is not active, the interconnect device 100 may perform an output PHY wake to wake an egress circuit 218 associated with the port 203b. If the port 203b is active, or upon waking the egress circuit 218 associated with the port 203b, the interconnect device 100 may begin forwarding the received data and/or data associated with the data such as packetized data from the port 203b.

As illustrated in FIG. 6, an interconnect device 100 may be configured to perform a method 600 of storing identifications of egress ports 203b in caches associated with ingress ports 203a in accordance with one or more of the implementations described herein. The method 600 may begin at 603 in which data is received at an ingress port 203a. Receiving the data at the ingress port 203a may also initiate steps of the method 500 as described above. The method 600 may be performed at any point in time in which data received at an interconnect device 100 is being or to be transmitted or forwarded by the interconnect device 100.

After the data is received via the ingress port 203a at 603, the interconnect device 100 may in some implementations identify an egress port 203b associated with the data at 606. For example, the interconnect device 100 may determine that data received at the ingress port 203a is being forwarded via a particular egress port 203b. The egress port 203b may be identified by determining the data, such as a packet, received at the ingress port 203a is scheduled to be sent from the egress port 203b at 612. In some implementations, the identification of the egress port 203b may be made in response to the interconnect device 100 scheduling a packet to be sent from the egress port 203b.

Scheduling the data received at the ingress port 203a to be sent from the egress port 203b at 612 may include organizing and prioritizing the transmission of packets through the egress port 203b. Scheduling may be implemented using one or more queues 221 and shared buffer circuits 224 associated with the egress port. For example, when a packet is scheduled to be sent from the egress port 203b the packet may be stored in a shared buffer circuit 224. A shared buffer circuit 224 may hold a packet until the packet can be transmitted from the egress port 203b. Scheduling may be performed in relation to one or more scheduling algorithms such as first in, first out, priority queuing, round-robin, etc.

Next, the interconnect device may save an identification of the egress port 203b forwarding the data in a cache 227 associated with the ingress port 203a at 609. Each egress port 203b of the interconnect device 100 may be associated with identifying information such as a number, an address, or another identification. Each ingress port 203a may be associated with a particular cache 227. Upon determining data being received at an ingress port 203a is being transmitted from a particular egress port 203b, the interconnect device 100 may write or otherwise store an identification of the particular egress port in the cache 227 associated with the ingress port 203a. In this way, the cache 227 may store a list of egress ports 203b recently used by the ingress port 203a.

Saving an identification of an egress port 203b may in some implementations involve, as illustrated, and described above, in relation to FIG. 4, memory 212 storing a number of caches 227a-c. Each cache 227 may be associated with a respective ingress port 203. Saving an identification of an egress port 203b may involve storing the identification in a cache 227 associated with the ingress port 203a which received the egress port 203b. As described above, egress ports 203b may be represented in the caches 227 in a number of ways in various implementations. As an example, each egress port 203b may be represented by a port number or by a bit of a binary number. When processing circuitry detects an ingress port 203a has received data which was or will be transmitted by a particular egress port 203b, the processing circuitry may edit the cache 227 associated with the ingress port to include an identification of the egress port 203b.

As referenced above, in some implementations the one or more egress ports 203b may be identified based on an output from an AI or machine learning (ML) model such as a reinforcement learning model. To train the model, egress port identifications stored in each cache 227 may be monitored or otherwise used as training data for the model. For example, upon receiving a packet at an ingress port 203a and scheduling the packet to be sent from an egress port 203b, a model may be trained based on an association of the ingress port 203a with the egress port 203b. Training data and/or models trained based on a specific interconnect device 100 may be used by the interconnect device 100 and/or other interconnect devices 100 to identify egress ports 203b to wake at 509 in a method 500 as described above.

In some implementations, identifications of egress ports 203b stored in a cache 227 may over time be removed from the cache 227. For example, an identification of an egress port 203b may be removed from a cache 227 after being in the cache 227 for a predetermined amount of time, e.g., minutes, hours, days, etc. In some implementations, caches 227 may have a limited storage capacity and the number of egress ports 203b identified in each cache 227 may be limited. Older entries in a cache 227 may be overwritten as new entries are added to the cache.

The present disclosure encompasses methods with fewer than all of the steps identified in FIGS. 5 and 6 (and the corresponding descriptions of the methods 500 and 600), as well as methods that include additional steps beyond those identified in FIGS. 5 and 6 (and the corresponding description of the methods 500 and 600). The present disclosure also encompasses methods that comprise one or more steps from the methods described herein, and or more steps from any other method described herein.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A device comprising one or more circuits to:
receive a request via an ingress port;
in response to receiving the request, identify one or more egress ports associated with the ingress port;
activate the one or more egress ports associated with the ingress port;
receive data via the ingress port;
process the data to identify an egress port associated with a destination of the data; and
schedule the data to be forwarded from the egress port associated with the destination of the data.

2. The device of claim 1, wherein the request is a request to wake the ingress port.

3. The device of claim 1, wherein the one or more circuits are further to wake the ingress port in parallel with activating the one or more egress ports in response to the request.

4. The device of claim 1, wherein the ingress port is deactivated and unable to receive data when the one or more egress ports are activated.

5. The device of claim 1, wherein the ingress port is associated with a cache in memory, and the one or more circuits identify the one or more egress ports associated with the ingress port by reading the cache.

6. The device of claim 5, wherein the one or more circuits are further to save an identification of the one or more egress ports associated with the destination of the data in the cache.

7. The device of claim 1, wherein the one or more circuits identify the one or more egress ports by receiving an output from a reinforcement learning model.

8. The device of claim 7, wherein the one or more circuits are further to train the reinforcement learning model based on the one or more egress ports associated with the destination of the data.

9. The device of claim 1, wherein the one or more circuits activate the one or more egress ports associated with the ingress port in parallel with performing an input negotiation associated with the ingress port.

10. The device of claim 1, wherein the one or more egress ports associated with the ingress port comprise a plurality of egress ports.

11. The device of claim 1, wherein the one or more circuits activate the one or more egress ports associated with the ingress port by exiting the one or more egress ports from a low power state.

12. The device of claim 1, wherein the one or more circuits activate the one or more egress ports associated with the ingress port prior to or in parallel with performing an output link decoding.

13. The device of claim 1, wherein the one or more circuits are further to activate the one or more egress ports associated with the destination of the data after activating the one or more egress ports associated with the ingress port.

14. A switch, comprising:
a plurality of ports; and
one or more circuits to:
receive a request via an ingress port;
in response to receiving the request, identify one or more egress ports associated with the ingress port;
activate the one or more egress ports associated with the ingress port;
receive data via the ingress port;
process the data to identify an egress port associated with a destination of the data; and
schedule the data to be forwarded from the egress port associated with the destination of the data.

15. The switch of claim 14, wherein the request is a request to wake the ingress port.

16. The switch of claim 14, wherein the one or more circuits are further to wake the ingress port in parallel with activating the one or more egress ports in response to the request.

17. The switch of claim 14, wherein the ingress port is deactivated and unable to receive data when the one or more egress ports are activated.

18. The switch of claim 14, wherein the ingress port is associated with a cache in memory, and the one or more circuits identify the one or more egress ports associated with the ingress port by reading the cache.

19. The switch of claim 18, wherein the one or more circuits are further to save an identification of the one or more egress ports associated with the destination of the data in the cache.

20. A method comprising:
receiving data via an ingress port;
in response to receiving the data via the ingress port, identifying one or more egress ports associated with the ingress port;
activating the one or more egress ports associated with the ingress port;
processing the data to identify an egress port associated with a destination of the data; and
scheduling the data to be forwarded from the egress port associated with the destination of the data.
